(19) United States
(12) Patent Application Publication
(10) Pub. No.: US 2009/0157686 A1
(43) Pub. Date: Jun. 18, 2009

(54) METHOD AND APPARATUS FOR EFFICIENTLY CACHING A SYSTEM-WIDE ACCESS CONTROL LIST

(75) Inventors: Sam Idicula, Mountain View, CA (US); Mohammed Irfan Rafiq, Santa Clara, CA (US); Nipun Agarwal, Santa Clara, CA (US)

Correspondence Address: PVF -- ORACLE INTERNATIONAL CORPORATION;c/o PARK, VAUGHAN & FLEMING LLP, 2820 FIFTH STREET, DAVIS, CA, 95618-7759, US

(73) Assignee: ORACLE INTERNATIONAL CORPORATION, Redwood Shores, CA (US)

(21) Appl. No.: 11/955,781

(22) Filed: Dec. 13, 2007

(51) Int. Cl. G06F 17/30

(52) U.S. Cl. 707/9; 707/E17.001

(57) ABSTRACT

One embodiment of the present invention provides a system for efficiently caching a system-wide Access Control Entry (ACE) for a subject requesting an action on an object associated with an application. During operation, the system retrieves a security class that is associated with an application. The system then checks if a constrained system-wide ACE associated with the subject, the object, the requested action, and the security class exists in a cache. If so, then the system retrieves the entry. Otherwise, the system retrieves a system-wide ACE associated with the subject and the requested action. The system also retrieves a local ACE associated with the subject, the object, the requested action, and the security class. Next, the system constrains the system-wide ACE with the local ACE and caches the result so that the constrained system-wide ACE is associated with the subject, the object, the requested action, and the security class.

### BACKGROUND

1. Field

The present disclosure relates to computer security. More specifically, the present disclosure relates to a method and an apparatus for efficiently caching a system-wide access control list.

2. Related Art

Access Control Lists (ACLs) can be used to control an entity's access to particular objects. For example, an entity such as a user might be restricted to a read action on an object such as a database of employee records. More specifically, an ACL is associated with a set of Access Control Entries (ACEs) that specify a subject's allowable actions on an object (these are also known as privileges). Moreover, a “system-wide ACE” specifies those privileges that a subject has over all objects (or a set of objects) in the system.

### SUMMARY

One embodiment of the present invention provides a system for efficiently caching a system-wide Access Control Entry (ACE) for a subject requesting an action on an object associated with an application. During operation, the system retrieves a security class that is associated with an application. The system then checks if a constrained system-wide ACE associated with the subject, the requested action, and the security class exists in a cache. If so, then the system retrieves the entry. Otherwise, the system retrieves a system-wide ACE associated with the subject and the requested action. The system also retrieves a local ACE associated with the subject, the object, the requested action, and the security class. Next, the system constrains the system-wide ACE with the local ACE and caches the result so that the constrained system-wide ACE is associated with the subject, the requested action, and the security class.

In a variation of this embodiment, the security class is an identifier for a set of access controls associated with an application.

In a further variation, the subject can include a user and a user's role.

In a further variation, the object can include a function and a subset of a database.

In a further variation, the action can include read, write, execute, create, and delete.

In a further variation, retrieving the local ACE associated with the subject involves retrieving an XML document representing an ACL for the object and the security class, parsing the retrieved XML document, and determining the local ACE associated with the subject and the request action from the parsed XML document.

In a further variation, constraining the system-wide ACE with the local ACE involves applying a three-valued logical AND operation to the system-wide ACE and the local ACE.

In a further variation, applying the three-valued logical AND operation to the system-wide ACE and the local ACE involves applying the following three-valued AND truth table:
if both the system-wide ACE and the local ACE are “grant,” then return “grant”;
if either the system-wide ACE or the local ACE is “deny,” then return “deny”;
otherwise, return “unknown.”

In a further variation, other three-valued logical AND operations can be used to combine the system-wide ACE and the local ACE.

In a further variation, caching the constrained system-wide ACE so that it is associated with the subject, the object, the requested action, and the security class involves the following translation:
if the constrained system-wide ACE is “grant,” then cache a “grant” bit of 1 and a “deny” bit of 0, so the “grant” bit and “deny” bit are associated with the subject, the object, the requested action, and the security class;
if the constrained system-wide ACE is “deny,” then cache a “grant” bit of 0 and a “deny” bit of 1, so that the “grant” bit and “deny” bit are associated with the subject, the object, the requested action, and the security class;
otherwise, cache a “grant” bit of 0 and a “deny” bit of 0, so that the “grant” bit and “deny” bit are associated with the subject, the object, the requested action, and the security class.

### BRIEF DESCRIPTION OF THE FIGURES

FIG. 1 presents an exemplary system-wide ACE caching system in accordance with an embodiment of the present invention.

FIG. 2 illustrates an association between a security class and a set of Access Control Lists (ACLs) in accordance with an embodiment of the present invention.

FIG. 3 illustrates a relationship between a subject, a user and a role in accordance with an embodiment of the present invention.

FIG. 4 illustrates a relationship between an object, a subset of a database and a function in accordance with an embodiment of the present invention.

FIG. 5 illustrates a relationship between an action and a read action, write action, a delete action, an execute action, and a create action in accordance with an embodiment of the present invention.

FIG. 6 presents an exemplary process for retrieving a local ACE associated with the subject, the object, the requested action, and the security class in accordance with an embodiment of the present invention.

FIG. 7 presents an exemplary process for applying a three-valued logical AND operation in accordance with an embodiment of the present invention.

FIGS. 8A and 8B present an exemplary process for caching a three-valued logic ACE.

FIGS. 9A, 9B, and 9C illustrate subsets of a database and various access control entries and subjects in accordance with an embodiment of the present invention.

FIG. 10 illustrates an XML ACL in accordance with an embodiment of the present invention.

FIG. 11 presents an exemplary computer system for caching system-wide access control entries in accordance with an embodiment of the present invention.

### DETAILED DESCRIPTION

The following description is presented to enable any user skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not intended to be limited to the embodiments shown, but is to be accorded the widest scope consistent with the principles and features disclosed herein.

The data structures and code described in this detailed description are typically stored on a computer-readable storage medium, which may be any device or medium that can store code and/or data for use by a computer system. This includes, but is not limited to, volatile memory, non-volatile memory, application-specific integrated circuits (ASICs), field-programmable gate arrays (FPGAs), magnetic and optical storage devices such as disk drives, magnetic tape, CDs (compact discs), DVDs (digital versatile discs or digital video discs), or other media capable of storing computer-readable media now known or later developed.

### Overview

Database servers typically implement access controls for the users of a database. This allows a database administrator to provide differential access to the database based on the user, the user's role, the requested action, and the data the user is requesting to access.

Specifically, a subject might be a user or a role; an object might be a subset of a database or a function; an action request might be a request to read, write, delete, execute, or create; and a permission might be grant, deny, or unknown. For example, a specific user such as “Amy Smith” (subject) might request a read access (requested action) on a particular row (object) in an employee salary database. Unless “Amy Smith” is a manager, she cannot access the salary data of other users. However, all employees can access the names of the employees and their titles. Additionally, a manager (a role as a subject) can execute all actions on the entire salary database (object). The set of allowable (grantable) or deniable actions are also known as “privileges.”

More generally, a subject can be any process that can request an action on an object. Note that an object can also include a function that can be executed. This allows functions as well as data to be restricted and flexibly controlled.

A local Access Control Entry (local ACE) is a permission associated with a particular subject, object, and action. A set of such ACEs can be associated with an Access Control List (ACL). Typically, an ACL is object-oriented, which associates the ACL's list with an object. However, an ACL can also be subject-oriented, which associates an ACL's list with a subject.

Since an ACL is a list of ACEs associated with an object, any operation on a local ACE can easily be repeated over a list of ACEs to yield an operation on the ACL. Hence, although this disclosure describes operations or definitions relative to a local ACE, it is understood that these operations or definitions are just as easily associated with an ACL.

A Security Class (SC) is associated with a set of ACEs for a particular application. For example, an application to review salaries might be associated with a particular SC, which is then associated with a set of ACEs. This allows a cluster of privileges to be shared across the SC.

A local ACE is a permission that is associated with a specific subject, object, and action. For example, a local ACE for “Amy Smith” might grant “Amy Smith” the privilege of accessing the salary data associated with “Amy Smith.”

A system-wide ACE is a local ACE that is not specific to a particular object. For example, a system-wide ACE might allow a specific employee read access to all objects in the system (or a set of objects) in the system.

In a variation of this embodiment, a system-wide ACE can be over all the subjects (or a set of subjects) in the system.

Between a local and system-wide ACE, multiple hierarchical levels are possible. For example, “Amy Smith” might be a manager-level employee, which is at the executive-level, which is at the co-owner-level of the company.

A local ACE can be represented in various ways. For example, an XML document might encode a local ACE for a particular security class and object. In order to retrieve a local ACE for a particular subject, the XML document is parsed and then the particular privilege associated with the subject and object is extracted. This XML-based process returns a local ACE.

ACEs can also inherit privileges from ancestor ACEs. For example, a child ACE can inherit privileges from a parent ACE. These privileges can be inherited through a constraining (conjunctive; AND) or an extending (disjunctive; OR) relationship.

In order to determine a constrained system-wide ACE, both a system-wide ACE and a local ACE are retrieved. The system-wide ACE (parent) is then constrained with the local ACE (child). This allows a system-wide ACE to override a local ACE, and vice versa. For example, a system-wide ACE might grant a certain privilege, whereas a local ACE might deny it.

Since determining a constrained system-wide ACE can involve parsing operations, processing operations, and constraining operations, efficiency can be improved by re-using previously parsed, processed, and constrained system-wide ACEs. More specifically, embodiments of the present invention can employ a caching process to efficiently cache and re-use a constrained system-wide ACE. Note that different embodiments of the present invention can also be implemented in different ways to represent a local ACE. For example, a local ACE can be represented as a set of ACEs (i.e., an ACL) associated with a particular object.

### Caching a System-Wide ACE

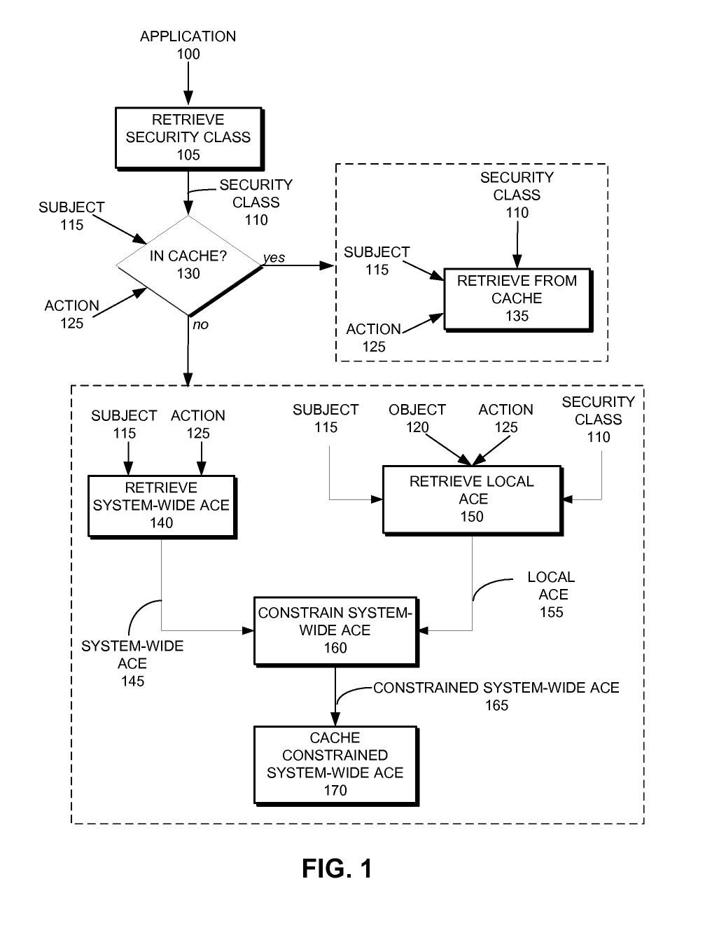

FIG. 1 presents an exemplary system for efficiently caching a system-wide ACE. During operation, the system retrieves (operation 105) the security class (data item 110) associated with the application (data 100).

The system then checks (operation 130) if the particular subject (data 115), action (data 125), and security class (data 110) are in the cache.

If the subject, action, and security class are in the cache (the “yes” branch of operation 130), then the system retrieves (operation 135) the constrained system-wide ACE from the cache based on the subject (data 115), action (data 125), and security class (data 110).

If the subject, object, action, and security class are not in the cache (the “no” branch of operation 130), then the system retrieves (operation 140) the system-wide ACE (data 145) associated with the subject (data 115) and action (data 125). As part of this “no” branch, the system also retrieves (operation 150) the local ACE (data 155) associated with the subject (data 115), object (data 120), action (data 125), and security class (data 110). The system then constrains the system-wide ACE (operation 160) given the system-wide ACE (data 145) and the local ACE (data 155). The system then caches (operation 170) the constrained system-wide ACE (data 165).

### Security Classes

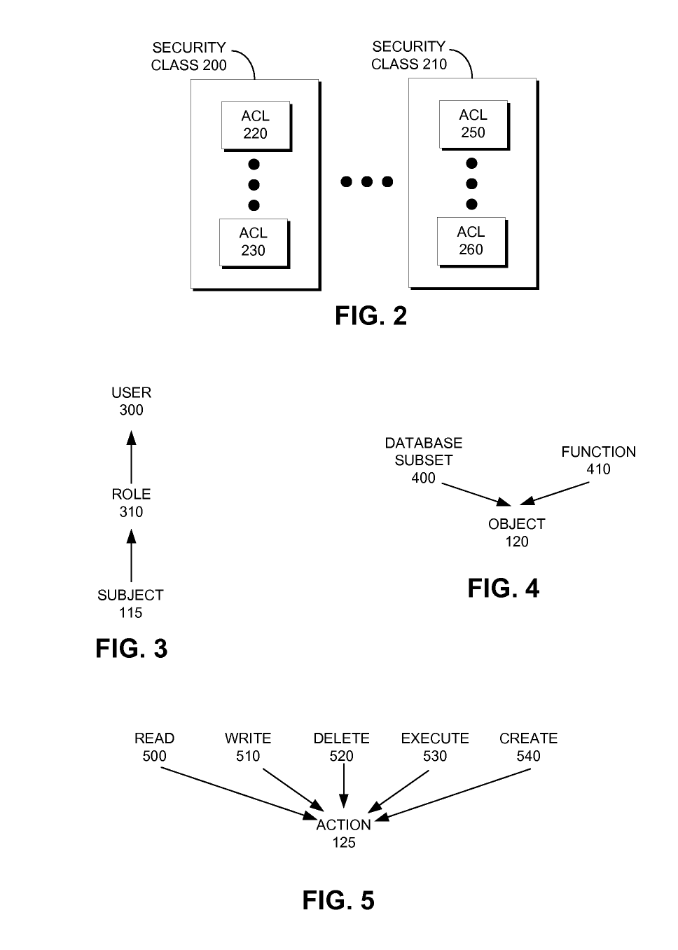

FIG. 2 illustrates an association between a security class and a set of Access Control Lists (ACLs) in accordance with an embodiment of the present invention. This association makes it convenient to retrieve a set of ACLs all associated with a specific application.

For example, Security Class 200 is associated with a set of ACLs (ACL 220 to ACL 230). Note that many such security classes can exist. For example, the figure illustrates a range of security classes: from Security Class 200 to Security Class 210. Note that the ACLs associated with a security class can also be ACEs.

### Subject Hierarchy

FIG. 3 illustrates a relationship between a subject (data 115) and a user (data 300) and a role (data 310) in accordance with an embodiment of the present invention. More specifically, this figure illustrates that a particular user can have a role, which is a type of subject. Multiple subject types can also be included between role and subject and between user and role. More generally, a subject is an entity which requests or applies an action to an object. Different actions and objects might have different subjects associated with them. For example, a system process might be a subject that can perform actions on certain objects.

### Object Hierarchy

FIG. 4 illustrates a relationship between an object (data 120) and a subset of a database (data 400) and a function (data 410) in accordance with an embodiment of the present invention. A subset of a database can include the database itself, a row of the database, a column of a database, or any other part of a database. A function is a data item that is associated with the execution of a process. More generally, an object is an entity to which an action is applied.

### Actions

FIG. 5 illustrates a relationship between an action (data 125) and a read action (data 500), a write action (data 510), a delete action (data 520), an execute action (data 530), and a create action (data 540) in accordance with an embodiment of the present invention. More generally, an action can cause a change in the state of an object. Moreover, different objects can be associated with a different set of actions, wherein actions on an object can be controlled with a local ACE for a particular subject.

### Retrieving a Local ACE

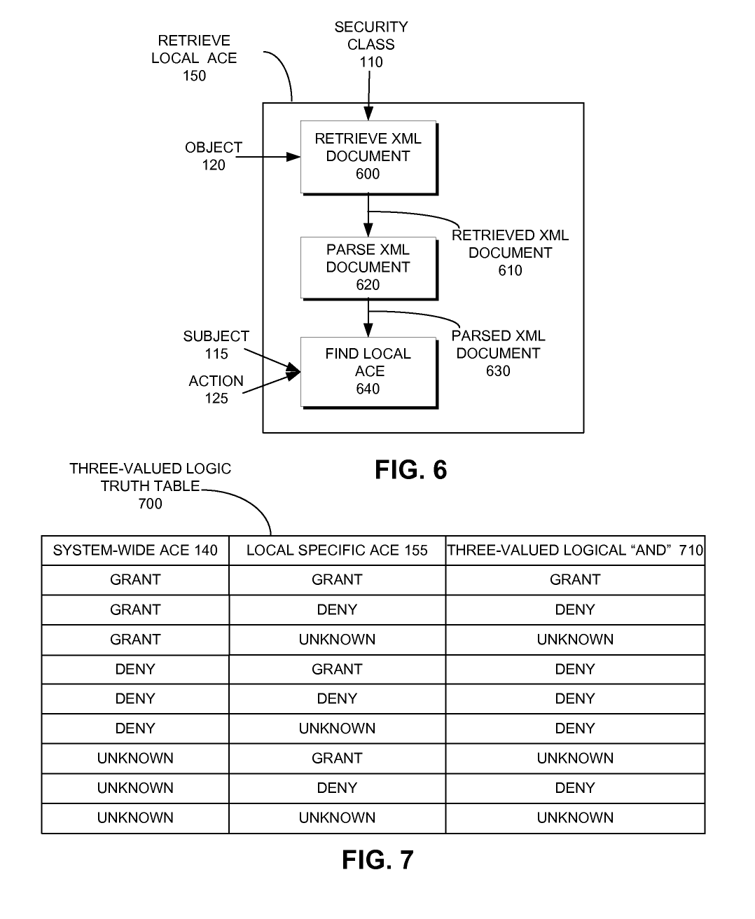

FIG. 6 presents an exemplary process for retrieving a local ACE (operation 150) associated with the subject (data 115), the object (data 120), the requested action (data 125), and the security class (data 110) in accordance with an embodiment of the present invention. The system first retrieves (operation 600) an XML document associated with the object and security class. Next it parses (operation 620) the retrieved XML document (data 610). Finally, it finds (operation 640) the local ACE from the parsed XML document (data 630) and given subject and action.

### Constraining Inheritance

FIG. 7 presents an exemplary process for applying a three-valued logical AND operation in accordance with an embodiment of the present invention. The figure shows a truth table for the three values “Grant,” “Deny” and “Unknown,” which represent the values of a privilege associated with a requested action. Given the system-wide ACE 140 and local ACE 155, the three-valued logical “AND” operation 710 represents the “AND” of the system-wide ACE and the local ACE. This “AND” operation represents constraining inheritance between the parent (system-wide ACE) and the child (local ACE). An extending inheritance is similar except it involves a three-valued logical “OR” operation instead.

### Caching a Constrained System-Wide ACE

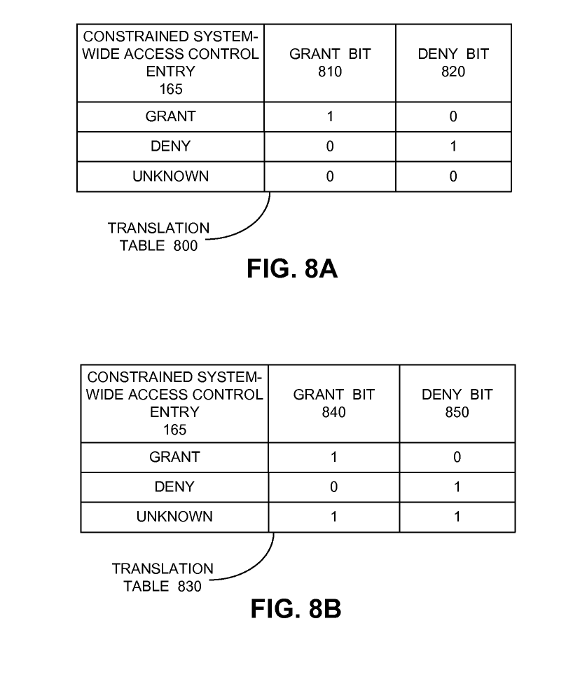

FIGS. 8A and 8B present an exemplary process for caching a three-valued constrained system-wide ACE (data 165). The system caches two bits for a single three-valued logical value: a grant bit (data 810 and 840) and a deny bit (data 820 and 850). If the constrained ACE is “Grant,” then the grant bit is 1 and the deny bit is 0; if the constrained ACE is “Deny,” then the grant bit is 0 and the deny bit is 1. If the constrained ACE is “Unknown,” then the grant bit is 0 and the deny bit is 0. In another embodiment, if the constrained ACE is “Unknown,” then the grant bit is 1 and the deny bit is 1. These embodiments are illustrated in translation tables 800 and 830, respectively.

### Illustrations of Access Control Entries for Roles and Users

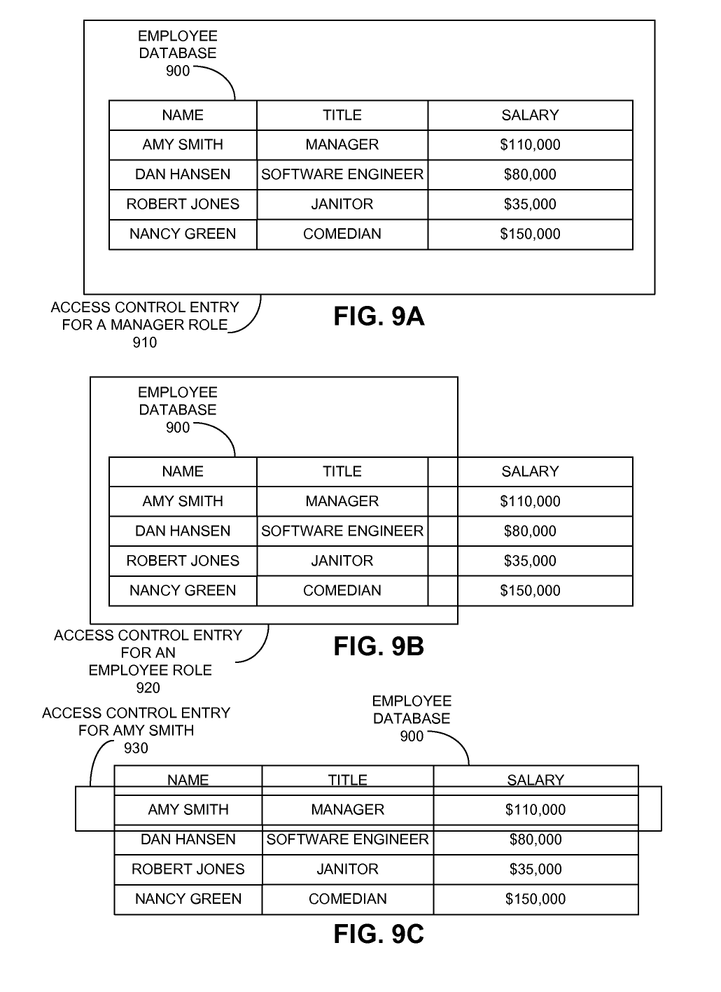

FIGS. 9A, 9B, and 9C illustrate subsets of a database (employee database 900) and various access control entries and subjects in accordance with an embodiment of the present invention. For example, FIG. 9A illustrates a local ACE for a manager role (data 910). Note that the manager might be allowed read access to all of the entries in the employee database. In contrast, FIG. 9B illustrates a local ACE for an employee role (data 920), wherein employees are allowed read access only to the names and titles of employees and not their salaries. FIG. 9C illustrates a local ACE for “Amy Smith” (data 930), wherein “Amy Smith” is only allowed to read the row associated with “Amy Smith.”

### XML-Based Access Control Lists

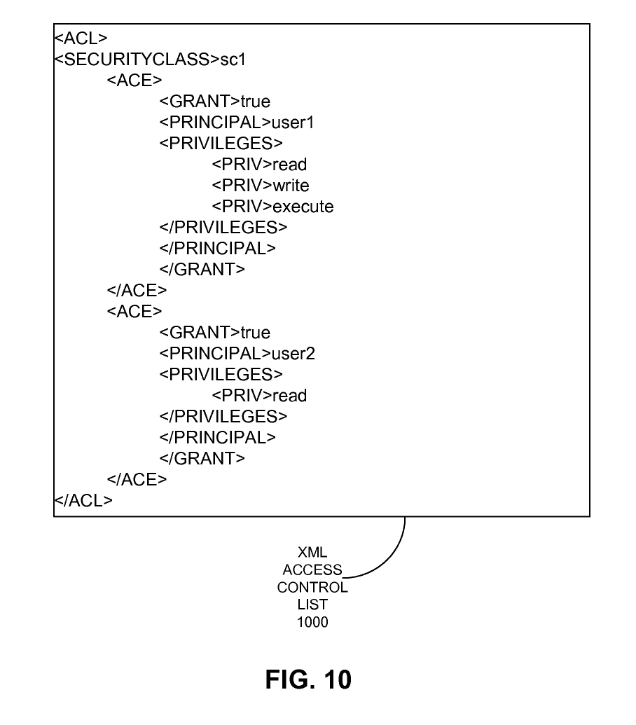

FIG. 10 illustrates an XML ACL (data 1000) in accordance with an embodiment of the present invention. This ACL is associated with security class “scl.” It also contains a set of ACEs, wherein there exists one ACE per user. For example, subject “user1” is allowed read, write, and execute privileges for the object associated with this ACL. Various XML-based techniques can be used to represent the same information. For example, the same information might be distributed in multiple XML documents.

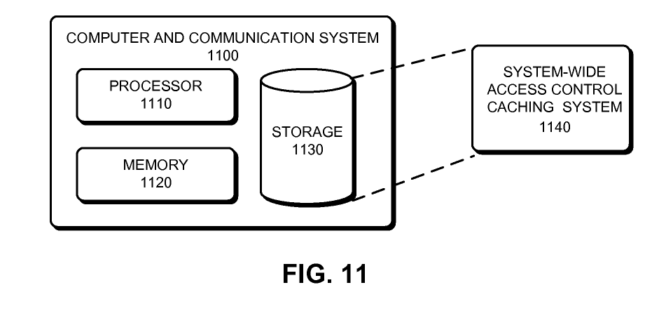

FIG. 11 presents an exemplary computer system for efficiently caching a system-wide ACE in accordance with an embodiment of the present invention. In FIG. 11, a computer and communication system 1100 includes a processor 1110, a memory 1120, and a storage device 1130. Storage device 1130 stores programs to be executed by processor 1110. Specifically, storage device 1130 stores a program that implements a system-wide access control caching system 1140. During operation, the program for performing system-wide access control caching operations 1140 is loaded from storage device 1130 into memory 1120 and is executed by processor 1110.

The foregoing descriptions of embodiments of the present invention have been presented for purposes of illustration and description only. They are not intended to be exhaustive or to limit the present invention to the forms disclosed. Accordingly, many modifications and variations will be apparent to practitioners skilled in the art. Additionally, the above disclosure is not intended to limit the present invention. The scope of the present invention is defined by the appended claims.

What is claimed is:

1. A computer-executed method for efficiently caching a system-wide access control entry for a subject requesting an action on an object which is associated with an application, comprising:
retrieving a security class associated with the application;
if a constrained system-wide access control entry associated with the subject, the requested action, and the security class exists in a cache, retrieving the constrained system-wide access control entry from the cache;
otherwise,
retrieving a system-wide access control entry associated with the subject and the requested action;
retrieving a local access control entry associated with the subject, the object, the requested action, and the security class;
constraining the system-wide access control entry with the local access control entry; and
caching the constrained system-wide access control entry so that the constrained system-wide access control entry is associated with the subject, the requested action, and the security class.

2. The method of claim 1, wherein the security class is an identifier for a set of access controls associated with an application.

3. The method of claim 1, wherein the subject is at least one of a user and a user's role.

4. The method of claim 1, where the object is at least one of a function and a subset of a database.

5. The method of claim 1, wherein the action is at least one of a read operation, a write operation, a delete operation, a create operation, and an execute operation.

6. The method of claim 1, wherein retrieving the local access control entry associated with the subject, the object, the requested action, and the security class comprises:
retrieving an XML document representing an access control list for the object and security class;
parsing the retrieved XML document; and
finding the local access control entry associated with the subject and the requested action from the parsed XML document.

7. The method of claim 1, wherein constraining the system-wide access control entry with the local access control entry comprises applying a three-valued logical AND operation to the system-wide access control entry and the local access control entry.

8. The method of claim 3, wherein applying a three-valued logical AND operation to the system-wide access control entry and the local access control entry involves:
returning grant if both the system-wide access control entry and the local ACE are grant;
otherwise, returning deny if either the system-wide access control entry or the local access control entry is deny;
otherwise, returning unknown.

9. The method of claim 1, wherein caching the constrained system-wide access control entry so that the constrained system-wide access control entry is associated with the subject, the object, the requested action, and the security class comprises:
if the constrained system-wide access control entry is grant, caching a grant bit of 1 and a deny bit of 0, so the grant bit and deny bit are associated with the subject, the object, the requested action, and the security class;
otherwise, if the constrained system-wide access control entry is deny, caching a grant bit of 0 and a deny bit of 1, so that the grant bit and deny bit are associated with the subject, the object, the requested action, and the security class;
otherwise, caching a grant bit of 0 and a deny bit of 0, so that the grant bit and deny bit are associated with the subject, the object, the requested action, and the security class.

10. An apparatus for efficiently caching a system-wide access control entry for a subject requesting an action on an object associated with an application, comprising:
a security-class retrieval mechanism configured to retrieve a security class associated with the application;
a cache lookup mechanism configured to determine if a constrained system-wide access control entry associated with the subject, the requested action, and the security class exists in a cache and then retrieve the constrained system-wide access control entry from the cache;
a system-wide retrieval mechanism configured to retrieve a system-wide access control entry associated with the subject and the requested action;
a local retrieval mechanism configured to retrieve a local access control entry associated with the subject, the object, the requested action, and the security class;
a constraining mechanism configured to constrain the system-wide access control entry with the local access control entry; and
a caching mechanism configured to cache the constrained system-wide access control entry so that the constrained system-wide access control entry is associated with the subject, the requested action, and the security class.

11. The apparatus of claim 10, wherein while retrieving the local access control entry associated with the subject, the object, the requested action, and the security class, the local retrieval mechanism is further configured to:
retrieve an XML document representing an access control list for the object and security class;
parse the retrieved XML document;
find the local access control entry associated with the subject and the requested action from the parsed XML document;
retrieve an XML document representing an access control list for the object and security class;
parse the retrieved XML document; and
find the local access control entry associated with the subject and the requested action from the parsed XML document.

12. The apparatus of claim 10, wherein while constraining the system-wide access control entry with the local access control entry, the constraining mechanism is further configured to apply a three-valued logical AND operation to the system-wide access control entry and the local access control entry.

13. The apparatus of claim 12, wherein while applying a three-valued logical AND operation to the system-wide access control entry and the local access control entry, the applying mechanism is further configured to:
return grant if both the system-wide access control entry and the local access control entry are grant;
return deny if either the system-wide access control entry or the local access control entry is deny; and
return unknown otherwise.

14. The apparatus of claim 11, wherein while caching the constrained system-wide access control entry so that the constrained system-wide access control entry is associated with the subject, the object, the requested action, and the security class, the caching mechanism is further configured to:
cache a grant bit of 1 and a deny bit of 0, so that the grant bit and deny bit are associated with the subject, the object, the requested action, and the security class if the constrained system-wide access control entry is grant;
cache a grant bit of 0 and a deny bit of 1, so that the grant bit and deny bit are associated with the subject, the object, the requested action, and the security class if the constrained system-wide access control entry is deny; and
cache a grant bit of 0 and a deny bit of 0, so that the grant bit and deny bit are associated with the subject, the object, the requested action, and the security class otherwise.

15. A computer-readable storage medium storing instructions that when executed by a computer cause the computer to perform a method for efficiently caching a system-wide access control entry for a subject requesting an action on an object which is associated with an application, the method comprising:
retrieving a security class associated with the application;
if a constrained system-wide access control entry associated with the subject, the requested action, and the security class exists in a cache, retrieving the constrained system-wide access control entry from the cache;
otherwise,
retrieving a system-wide access control entry associated with the subject and the requested action;
retrieving a local access control entry associated with the subject, the object, the requested action, and the security class;
constraining the system-wide access control entry with the local access control entry; and
caching the constrained system-wide access control entry so that the constrained system-wide access control entry is associated with the subject, the requested action, and the security class.
